(19) United States
(12) Patent Application Publication
(10) Pub. No.: US 2026/0067321 A1
(43) Pub. Date: Mar. 5, 2026

(54) METHOD FOR VULNERABILITY SCANNING AND AN ARRANGEMENT FOR VULNERABLITY SCANNING

(71) Applicant: WithSecure Corporation, Helsinki (FI)

(72) Inventors: Jarno NIEMELÄ, Helsinki (FI); Domenico GARGANO, Helsinki (FI)

(21) Appl. No.: 19/309,749

(22) Filed: Aug. 26, 2025

(30) Foreign Application Priority Data
Aug. 27, 2024 (GB) 2412513.0

(51) Int. Cl. H04L 9/40

(52) U.S. Cl. CPC H04L 63/1433; H04L 63/1425

(57) ABSTRACT

An arrangement and a method for vulnerability scanning in a network, the network comprising at least one host, such as an endpoint and/or a server. The method comprises collecting host specific information relating to resources of hosts in the network by detecting and/or analyzing processes executing at the hosts and/or network traffic at the hosts, the resources of the hosts relating to at least one of the following: processes being executed at the hosts, ports used by the hosts, protocols used by the hosts. The method further comprises building and/or updating a database comprising information relating to the hosts and resources of the hosts based at least in part of the collected host specific information and performing a vulnerability scan of the network by scanning the resources of the hosts at least in part based on the built database for the hosts.

### CROSS-REFERENCE TO RELATED APPLICATION

This application claims the benefit of and priority to United Kingdom (GB) Patent Application No. 2412513.0 filed Aug. 27, 2024, the contents of which being incorporated by reference in their entirety herein.

### TECHNICAL FIELD

The present disclosure relates to a method for vulnerability scanning and an arrangement for vulnerability scanning.

### BACKGROUND

Security and threat detection systems for computers and computer networks are used to detect threats and anomalies in computers and computer networks. Examples of such are Endpoint Protection Platform (EPP), Endpoint Detection & Response (EDR) and Managed Detection and Response (MDR) products and services. An endpoint protection platform (EPP) is a solution deployed on endpoint devices to prevent file-based malware attacks and to detect malicious activity. Also, EDR systems focus on the detection and monitoring of a breach as it occurs and helps to determine how best to respond the detected breach. EDR systems also provide the investigation and remediation capabilities needed to respond to dynamic security incidents and alerts. MDR in turn is a managed cybersecurity service providing service for threat detection, response, and remediation.

In the recent years, vulnerability management systems have also become more widely used. These systems primarily focus on identifying and addressing vulnerabilities within an organization's IT infrastructure, applications, and systems. Vulnerability management systems can for example systematically scan, assess, and prioritize vulnerabilities to determine which pose the greatest risk to the organization. Based on this information the vulnerability management system can e.g. patch or control patching of existing vulnerabilities and thus reduce the attack surface by proactively identifying and mitigating vulnerabilities before they can be exploited by attackers. Risk management and evaluation can be taken further with Exposure Management systems which not only take care of scanning and analyzing vulnerabilities but also other factors that contribute to the organization's risk exposure, such as threat landscape, business impact, and effectiveness of security controls.

The existing vulnerability scanning solutions which can be utilized e.g. in exposure management systems, are difficult for administrators to configure. In the existing prior art solutions, the administrators have to manually configure the vulnerability scanning solution, e.g. define what hosts, port ranges, protocols, etc. are scanned. Therefore, vulnerability scanning is time-consuming to carry out and the expertise of the administrators may have big influence on the reliability of the vulnerability scanning results.

For this reason, more reliable and easily configurable vulnerability scanning methods are needed.

### BRIEF SUMMARY

The following presents a simplified summary in order to provide basic understanding of some aspects of various embodiments of the disclosure. The summary is not an extensive overview of the disclosure. It is neither intended to identify key or critical elements of the disclosure, nor to delineate the scope of the disclosure. The following summary merely presents some concepts of the disclosure in a simplified form as a prelude to a more detailed description of example embodiments of the disclosure.

According to a first aspect, the disclosure relates to a method, e.g. a computer implemented method, for vulnerability scanning in a network, the network comprising at least one host, such as an endpoint and/or a server. The method comprises collecting host specific information relating to resources of hosts in the network by detecting and/or analyzing processes executing at the hosts and/or network traffic at the hosts, the resources of the hosts relating to at least one of the following: processes being executed at the hosts, ports used by the hosts, protocols used by the hosts. The method further comprises building and/or updating a database, e.g. a resource database, such as an information repository, comprising information relating to the hosts and resources of the hosts based at least in part of the collected host specific information, and performing a vulnerability scan of the network by scanning the resources of the hosts at least in part based on the built database for the hosts.

In one embodiment of the disclosure only the ports and/or protocols of the hosts are scanned in the vulnerability scan which the hosts are using based on the host specific information of the database.

In one embodiment of the disclosure the host specific information relating to the resources of the host is collected by at least one security agent installed to at least one host and/or network, the security agent being e.g. an xDR agent, EDR-agent, MDR-agent, EPP-agent, a vulnerability management system, software catalog, a device firewall, a device application control software and/or a network firewall.

In one embodiment of the disclosure the host is monitoring for configuration changes on the host and/or software being added to the host, e.g. by an agent installed to the host, and/or wherein information related to the changes and/or software being added to the host is submitted to be included to the host specific information in the database.

In one embodiment of the disclosure the scope of the vulnerability scan at the host is at least in part based on the monitored configuration changes and/or software being added, e.g. so that the vulnerability scan scans only the ports and protocols used by the host.

In one embodiment of the disclosure the collected information, e.g. host specific information, relates to at least one of the following: what applications are listening to which network ports at a host, what processes and/or applications the host is executing, what are the names of the processes and/or applications, what are the version strings of the processes and/or applications, what are the vendors of the processes and/or applications, what is an IP address of the host, what is operating system of the host.

In one embodiment of the disclosure the method comprises carrying out a full and/or complete scan, e.g. a port scan and/or a vulnerability scan, of a host and/or a network, wherein the results are compared with the collected information of the database, and wherein an alert is created and/or sent if there are resources used by the host(s), such as ports, which are not present in the host specific collected information of the database.

In one embodiment of the disclosure the method further comprises requesting the host to confirm that the resources, such as used ports, are not used by the host before creating and/or sending the alert.

In one embodiment of the disclosure the method comprises carrying out a port scan on the at least one host, and if previously unused ports are found to be used with the port scan, a vulnerability scan for the host is carried out.

In one embodiment of the disclosure the method comprises scanning at least one cloud service entity, e.g. a virtual server, and information related to the at least one cloud service entity is submitted to be included to the database.

In one embodiment of the disclosure the method comprises scanning only those cloud service entities that are determined to be present based on the database.

According to a second aspect, the disclosure relates to an arrangement for vulnerability scanning comprising at least one host for coordinating and/or carrying out a vulnerability scan in a network, the network comprising at least one host, such as an endpoint and/or a server. The arrangement is configured to collect host specific information relating to resources of the hosts by detecting and analyzing processes executing at the hosts and/or network traffic at the hosts, the resources of the hosts relating to at least one of the following: processes being executed at the hosts, ports used by the hosts, protocols used by the hosts. The arrangement is further configured to build and/or to update a database about the resources of hosts based at least in part of the collected host specific information, the database comprising information relating to the hosts and resources of the hosts, and to perform a vulnerability scan of the network by scanning the resources of the hosts at least in part based on the built database for the hosts.

In one embodiment of the disclosure the arrangement is configured to carry out a method according to any embodiment of the disclosure.

According to a third aspect, the disclosure relates to a computer program comprising instructions which, when executed by a computer, e.g. an arrangement, cause the computer to carry out a method according to the disclosure.

According to a fourth aspect, the disclosure relates to a non-transitory computer-readable medium comprising the computer program according to the disclosure.

With the solution of the disclosure, its possible to provide reliable vulnerability scanning results which do not require extensive manual configuration from the administrators. The solution of the disclosure makes it possible to carry out vulnerability scans for only the resources that are used in real life and no full scanning (of everything not even in use) is needed. This reduces the time required for vulnerability scans and obtaining vulnerability scan results. Also, the experience of the administrators does not have big effect on the reliability of the vulnerability scan results as the vulnerability scan configuration can be prepared automatically. With the solution of the disclosure also dynamic fast responses can be provided for the users and/or administrators, that they can then iteratively work with. The solution of the disclosure can utilize different components installed to a host and/or endpoint, e.g. EPP, EDR, update management, software catalogue and other agent software installations, and their API integrations, etc. to obtain a comprehensive view on what is actually executing on given hosts or endpoints and thus that information can be used to build a dynamic scan configuration that will scan and/or test for example only the ports and protocols in which a given host has something responding to.

Various example and non-limiting embodiments of the disclosure both as to constructions and to methods of operation, together with additional objects and advantages thereof, will be best understood from the following description of specific example and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

The embodiments of the disclosure are illustrated by way of example, and not by way of limitation, in the figures of the accompanying drawings.

FIG. 1 presents schematically an example network architecture of one embodiment of the disclosure.

FIG. 2 presents schematically an example network architecture of one embodiment of the disclosure.

FIG. 3 presents an example method according to one embodiment of the disclosure.

FIG. 4 presents an example computing device, such as a server, according to one embodiment of the disclosure.

### DETAILED DESCRIPTION

Vulnerability scanning and vulnerability management systems focus on identifying and/or addressing vulnerabilities and/or misconfigurations e.g. within an organization's IT infrastructure, applications, and systems. Vulnerability management systems can for example systematically scan, assess, and prioritize vulnerabilities to determine which pose the greatest risk to the organization. Based on this information the vulnerability management system can e.g. patch or control patching of existing vulnerabilities and thus reduce the attack surface by proactively identifying and mitigating vulnerabilities before they can be exploited by attackers.

A vulnerability scanning solution or vulnerability management system or service of the present disclosure may be part of a threat detection system or a separate system. In one embodiment of the disclosure the vulnerability management system or the threat detection system according to one embodiment of the disclosure may comprise hosts, e.g. at least one endpoint and a backend system comprising at least one backend server. In this case information, e.g. threat detection related data, can be shared between the hosts, e.g. between the endpoints and/or between the endpoints and the backend system.

Vulnerability scanning or vulnerability management system or service, e.g. based on the solution of the disclosure, can be used with other thread detection or threat prevention systems, such as EPP-, EDR- and/or MDR-system. Any of these systems may deploy data collectors or processing units, such as agents or sensors, on selected network endpoints, which can be any elements of IT infrastructure. Typically agents of EPP-system can focus on endpoint protection and thus on data processing while agents of EDR-system can focus on detection functions and thus on data collection. The data collectors observe activities happening at the endpoint and they cand send the collected data to a central, backend system, for example located in the cloud. When the backend receives data, the data can be processed (e.g. aggregated and enriched) before being analyzed and scanned by the security system provider for signs of security breaches and anomalies.

The solution of the disclosure can be utilized for example in end point protection (EPP) systems. In one embodiment of the disclosure the hosts or computers can be protected by a threat detection system, such as an end point protection (EPP) or an EDR system. These systems can comprise endpoint-side security controls which make decisions both locally and in a decentralized fashion, e.g. so that some functional elements, such as facilitating attack detection processes, are hosted remotely. The local decision-making process can rely on specific and simple (and hence often false negative-prone) security controls aiming on prompt and reliable prevention of known attacks and their variants. In uncertain situations, ambiguous objects, such as previously unseen, untrusted executables and contexts of their appearances, are analyzed by remote services which can offer broader and more complex detection analysis tools than the tools on the local hosts or endpoints. The remote services can for example utilize machine learning models that scrutinize the objects via deep static and dynamic inspection. In one embodiment of the disclosure an electronic file can be analyzed for malware, electronic file e.g. encompassing any electronic file including a runnable/executable part, such as any kind of application file. Insofar, example embodiments of the present disclosure are applicable to any such electronic file, including for example a file of an Android Application Package (APK), a Portable Executable (PE), a Microsoft Windows Installer (MSI) or any other format capable of distributing and/or installing application software or middleware on a computer.

The solution of the disclosure can be utilized for example in EDR- or MDR-systems. In EDR/MDR-systems the EDR/MDR-agents can consume data from EDR/MDR-sensor components, perform initial analysis to determine whether a given activity (e.g. a series of events) matches with an initial definition of malicious (e.g. suspicious, informative) behavior and, if so, forward the information to the EDR/MDR-backend. This information can be collected by an agent component to provide context information so that an informed decision can be made regarding actions to be taken. EDR/MDR-backend can further analyze the information received from the agents deployed in an environment. EDR/MDR-sensors can work passively by intercepting data flowing through the system processes and as the sensors often need to sit inline of the processes, they must work fast. EDR/MDR-backend can pass the data to its decision logic using various methods, e.g. heuristics or rules databases, to ascertain whether the activity is benign, meets its threshold for being logged, highlighted as suspicious, malicious, etc.

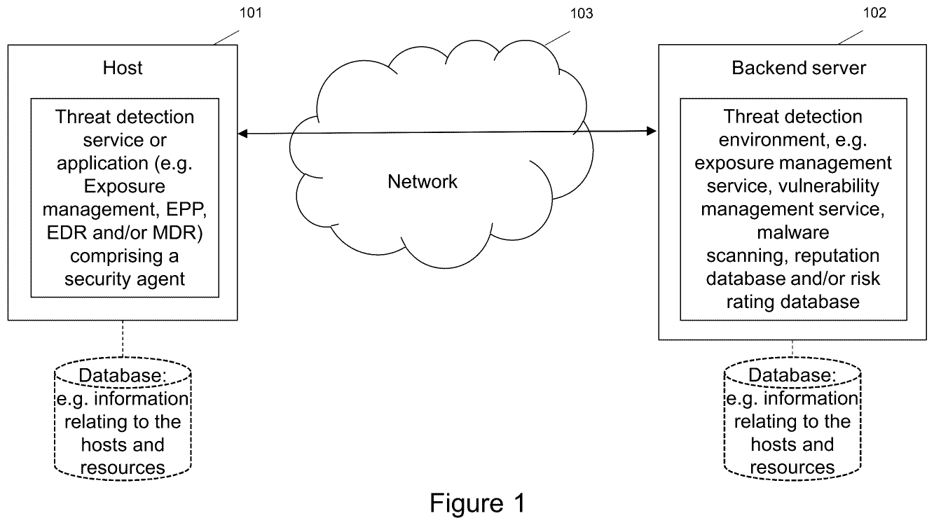

FIG. 1 presents an example environment in which the solution of the disclosure can be used. In the solution of FIG. 1 a system configuration is presented in which a local host 101, such as an endpoint, and a remote entity or server 102 are connected via a network 103. Here, the host 101 exemplifies any computer or communication system, including a single device, a network node or a combination of devices, on which vulnerability scanning, malware scanning or collection of threat detection related information is to be performed. The scanning and/or analysis of the threat detection and/or vulnerability related data can be done at the endpoint and/or at the server. For example, the host 101 may include an endpoint, a personal computer, a personal communication device, a network-enabled device, a client, a firewall, a mail server, a proxy server, a database server, or the like. The server 102 exemplifies any computer or communication system, including a single device, a network node or a combination of devices, on which vulnerability scanning, malware scanning or threat detection data analysis can be performed for the host 101 (such as an endpoint) or which can provide data for the host 101 (such as an endpoint) required to carry out required operations, e.g. vulnerability scanning, malware scanning, threat detection related analysis, such as risk rating, reputation data and/or attack path attack path mapping. For example, the server 102 may include a security entity or a backend entity of a security provider, or the like, and the server 102 may be realized in a cloud implementation or the like. In the solution of the disclosure information related to the hosts and resources of the hosts can be collected and stored to a database, e.g. a database of a host and/or a database of a backend.

According to example embodiments of the disclosure, vulnerability scanning, malware scanning and/or threat detection data analysis at the host 101 and/or by the server 102 can be realized using a vulnerability scanning or threat detection environment, such as a virtual machine or emulator environment, arranged at the host and/or at the server. For example, an agent or sensor can be installed/arranged at the host 101 to be used for vulnerability scanning, malware scanning and/or threat detection data analysis. In one embodiment of the disclosure a sensor or agent at the computer is used to allow to intercept a file, a system configuration value and/or network operations called by the application. The sensor can be used to observe operation of the device, such as a computer, and information collected by the sensor can be used to detect malicious behavior of an application, a file and/or a process.

In one embodiment of the disclosure the vulnerability scanning environment, malware scanning environment or threat detection service and/or software can detect starting and closing of applications, all unusual processes and attach monitoring to the required applications and processes. Also, when the services are started early, the service is able to detect and follow (at least most of) user's applications. In one embodiment of the disclosure, when the malware scanning software or service is started up, it can perform running application inventory.

The network 103 exemplifies any computer or communication network, including e.g. a (wired or wireless) local area network like LAN, WLAN, Ethernet, or the like, a (wired or wireless) wide area network like WiMAX, GSM, UMTS, LTE, or the like, and so on. Hence, the host 101 and the server 102 can but do not need to be located at different locations. For example, the network 103 may be any kind of TCP/IP-based network. Insofar, communication between the host 101 and the server 102 over the network 103 can be realized using for example any standard or proprietary protocol carried over TCP/IP, and in such protocol the agent at the host 101 and the threat detection related service or application at the server 102 can be represented on/as the application layer.

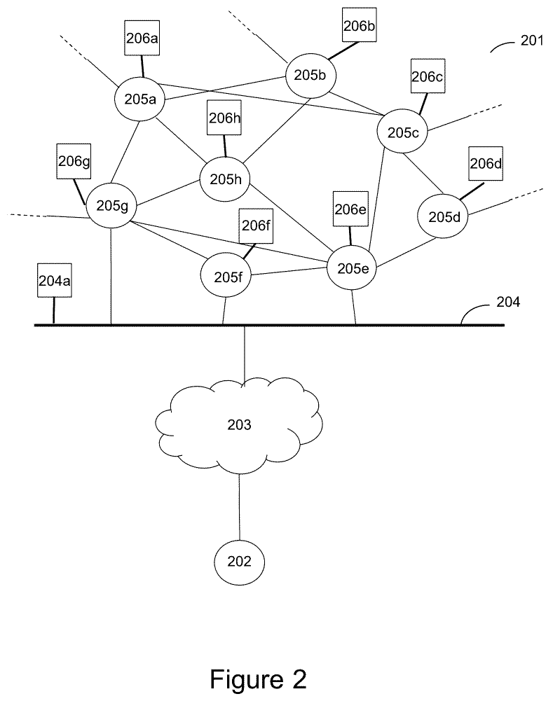

FIG. 2 presents schematically also an example network architecture of one embodiment of the disclosure in which the solution of the disclosure can be used. In FIG. 2 a part of a first local computer network 201 is schematically illustrated into which a computer system, for example a vulnerability management, an exposure management, EPP or an EDR system, has been installed. Also, any other computer system that is able to implement the embodiments of the disclosure can be used instead or in addition to the exposure management, EPP or EDR system used in this example. The first local computer network is connected to a security service network, in one embodiment a security backend system or server 202, through a network 203. The network can be similar as the network 103 in FIG. 1. The backend system or server 202 can be similar as the server 102 of FIG. 1. The backend system or server 202 can form a node on the security service computer network relative to the first local computer network. The security service computer network can be managed by a vulnerability management or threat detection system provider and may be separated from the network 203 by a gateway or other interface (not shown) or other network elements appropriate for the backend 202. The first local computer network 201 may also be separated from the network 203 by a gateway 204 or other interface. Other network structures are also possible.

The first local computer network 201 may be formed of a plurality of interconnected network nodes 205a-205h, each representing an element in the first local computer network 201 such as a computer, smartphone, tablet, laptop, or other piece of network enabled hardware. In one embodiment of the disclosure the node is any device on the network but not a gateway. Each network node 205a-205h shown in the first local computer network can also represent an endpoint, e.g. an EDR endpoint and/or EPP endpoint, onto which an agent or a sensor 206a-206h, that may include a data collector or sensor, is installed. The network nodes 205a-205h can be similar as the local host 101 of Figure. The agent or sensor may also be installed in some embodiments of the disclosure on any other element of the computer network, such as on the gateway or other interface. In the example of FIG. 2 a security agent module 204a has been installed on the gateway 204. In one embodiment of the disclosure the agents or sensors can be vulnerability scanning and/or malware scanning agents or sensors or sensor that collect information related to vulnerability scanning and/or malware scanning. The agents or sensors, 206a-206h, 204a can collect various types of data at the nodes 205a-205h or gateway 204 including, for example, program or file hashes, files stored at the nodes 205a-205h, logs of network traffic, process logs, binaries or files carved from memory (e.g. DLL, EXE, or memory forensics artefacts), and/or logs from monitoring actions executed by programs or scripts running on the nodes 205a-205h or gateway 204 (e.g. TCP dumps). The agents or sensors, 206a-206h, 204a can also carry out other tasks, e.g. collect information for vulnerability scan purposes. The data collected may be stored in a database or similar model for information storage for further use and/or sent to for further analysis. Any kind of threat detection models may further be constructed at the backend/server 202, and/or at a second server and be stored in the database. The nodes 205a-205h and the server 202 typically comprise a hard drive, a processor, and RAM.

Any type of data which can assist in detecting and monitoring a vulnerability and/or a security threat such as a security breach or intrusion into the system and/or an attack path verification task, may be collected by the agents or sensors 206a-206h, 204a during their lifecycle and that the types of data which are observed and collected may be set according to rules defined by the system provider upon installation of the system and/or when distributing components of the system, e.g. a threat detection model. In an embodiment, a suspicious or malicious event among the monitored events may be detected by one or more detection mechanisms used. In an embodiment, the detection mechanisms used to detect the suspicious or malicious event and/or a vulnerability may comprise using e.g. at least one of the following: a machine learning model, a scanning engine, a heuristic rule, a statistical anomaly detection, a fuzzy logic-based model, predetermined rules.

In an embodiment of the present disclosure, at least part of the agents or sensors 206a-206h may also have capabilities to make decisions on the types of data observed and collected themselves. For example, the agents or sensors 206a-206h, 204a may scan vulnerabilities and/or misconfigurations and/or collect data about the behavior of programs running on an endpoint and can observe when new programs are started. Where suitable resources are available, the collected data may be stored permanently or temporarily by the agents or sensors 206a-206h, 204a at their respective network nodes or at a suitable storage location on the first local computer network 201 and/or sent further.

The agents or sensors 206a-206h, 204a can be set up such that they send information such as the data they have collected or send and receive instructions to/from the threat detection system and/or vulnerability management system backend 202 through the network 203, such as internet. This allows the threat detection system or vulnerability management system provider to remotely manage the system without having to maintain a constant human presence at the organization which administers the first local computer network 201 and/or to send tasks to agents of e.g. a network and/or a host.

In one embodiment of the disclosure, the agents or sensors 206a-206h, 204a can also be configured to establish an internal network, e.g. an internal swarm intelligence network, that comprises the agents or sensors of the plurality of interconnected network nodes 205a-205h of the local computer network 201. As the agents or sensors 206a-206h, 204a collect data related to the respective network nodes 205a-205h of each agent or sensor 206a-206h, 204a, they are further configured to share information that is based on the collected data in the established internal network. In one embodiment a swarm intelligence network is comprised of multiple semi-independent security nodes (security agent modules) which are capable of functioning on their own as well. Thus, the numbers of instances in a swarm intelligence network may well vary. There may also be more than one connected swarm intelligence networks in one local computer network, which collaborate with one another.

The agents or sensors 206a-206h, 204a and/or the backend system can be further configured to use the collected data and information received from the internal network for generating and adapting models related to the respective network node 205a-205h and/or its users and/or to detect vulnerabilities and/or misconfigurations based on the collected data and information.

With the modern cyber security tools, such as EPP, xDR, EDR, MDR, update management, software catalogue and other agent software installations and their API integrations, there's a possibility of receiving a comprehensive view on what is actually executing on different parts of a network, e.g. on given hosts and/or endpoints. With the solution of the disclosure that information can be used to build a dynamic vulnerability scan configuration that will test only relevant part of the hosts (e.g. an endpoint and/or a server) and/or the network, for example so that only the ports and protocols are scanned in which a given host has something responding to.

In the solution of the disclosure the host specific information relating to resources of hosts in the network is collected by detecting and/or analyzing processes executing at the hosts and/or network traffic at the hosts. Based (at least in part) on the collected host specific information a database, e.g. comprising information relating to the hosts and resources of hosts, can be built and/or updated. A vulnerability scan of the network can be performed by scanning the resources of the hosts at least in part based on the built database (e.g. the information repository) for the hosts. In one embodiment of the disclosure for example only the ports and/or protocols of the hosts are scanned in the vulnerability scan which the hosts are using based on the host specific information in the database.

The host specific information relating to the resources of the host can be collected by at least one security agent installed to the host and/or network. The security agent can be for example an xDR agent, EDR-agent, MDR-agent, EPP-agent, a vulnerability management system, software catalog, a device firewall, a device application control software and/or a network firewall. In one embodiment of the disclosure information relating to resources of the hosts are collected from multiple sources, e.g. from multiple sources in the above list.

The collected information and/or the database may comprise for example the following information relating to different hosts and the resources of the hosts: processes a host has executing, names of the processes a host is executing, version strings of the processes a host is executing, vendors of the processes a host is executing, the applications to which a processes belong to, ports the processes are listening on a host, IP address(es) of a host has, operating system of a host. The above-mentioned information can be host specific information, e.g. so that each host is collected at least some of the above mentioned information and/or so that the above information is stored to the database for each host, for example separately.

In one embodiment of the disclosure, when a configuration change and/or software being added is detected, e.g. at the host, a tailored scan, e.g. a vulnerability scan, can be triggered that scans only the ports and protocols required. Thus a possibility to give near real time vulnerability scan results can be provided to the users with minimal overhead. In one embodiment of the disclosure the host is monitoring for configuration changes on the host and/or software being added to the host, e.g. by an agent installed to the host, and/or wherein information related to the changes and/or software being added to the host is submitted to be included to the host specific information in the database. In one embodiment of the disclosure the scope of the vulnerability scan at the host is at least in part based on the monitored configuration changes and/or software being added, e.g. so that the vulnerability scan scans only the ports and protocols used by the host.

The collected information can also be used for performing a full port scan on a given host, and the scan results can be compared against what is running on the host. If there are for example ports responding to packets and there is no knowledge on that host of any process listening on the given port, it is an indication that the host may be compromised and e.g. have either software, or hardware level rootkit running on it, for example compromised Intel Active Management technology or other out of band management firmware. In one embodiment of the disclosure the method comprises carrying out a full and/or complete scan, e.g. a port scan and/or a vulnerability scan, of a host and/or a network, wherein the results are compared with the collected information of the database, and wherein an alert is created and/or sent if there are resources used by the host(s), such as ports, which are not present in the host specific collected information of the database. The host can be requested to confirm that the resources, such as used ports, are not used by the host before creating and/or sending the alert. In one embodiment of the disclosure the method comprises carrying out a port scan on the at least one host, and if previously unused ports are found to be used with the port scan, a vulnerability scan for the host is carried out.

In one embodiment of the disclosure the method comprises scanning at least one cloud service entity, e.g. a virtual server, and information related to the at least one cloud service entity is submitted to be included to the database. The method comprises scanning only those cloud service entities that are determined to be present based on the database.

In one example embodiment, the solution of the disclosure can be used in the following way. When a corporate administrator requires the vulnerability management to perform a quick scan, the database can be used to dynamically optimize the scan operation for each host, e.g. by scanning only the ports and protocols on that host, based on the collected host specific information in the database. When a corporate administrator requests a complete scan, the database can be used to see which ports and protocols should respond, and the system can perform and/or send an alert on any new ports that do not have a known application responding to that port. In one example embodiment, in order to avoid false alarms, e.g. caused by race condition between new software installation and time it took for comprehensive scan to reach that host, a request can be sent to the agent software on that host to verify is there some new process added that would be listening to that port. Once the optimization of complete scan is made, the cyber security system carrying out vulnerability scanning can switch to “real time mode” in which any software installation, configuration, firewall, and other changes can trigger a tailored scan that covers only what is required to analyze a determined change, e.g. in configuration and/or installed software.

The solution of the disclosure can be utilized for example in exposure management in which the exposure of a resource is determined. In exposure management data, e.g. vulnerability and/or misconfiguration related data, collected from multiple sources can be processed for shaping and maintaining asset inventories and further analysed for addressing the awareness aspect e.g. via collecting asset inventory variations and general properties of assets, shaping their vulnerability scopes and postures, scoring reputations of for example public assets, supply chain providers, AI providers, etc.

A misconfiguration and/or vulnerability related information can comprise for example at least one of the following: remote code execution in publicly visible service, phishing opportunity due to user having a vulnerable client or player software installed, a client software application by which user can execute an application by clicking, such as an email client, a web browser, an instant messaging client, system information and/or process execution logs, e.g. which indicate(s) that an installed application has been used for phishing. The misconfiguration and/or vulnerability related information can be used for example for detecting an entry attack vector to a host and/or detecting different parts of an attack path.

The solution of the disclosure can utilize threat detection service or system, e.g. at the hosts and/or the network. The threat detection system and/or service can comprise different components, for example processing or analysis services, external data sources and/or internal data sources. Processing or analysis services can comprise at least one of the following: static parsers, dynamic parsers, antivirus engines, EDR/MDR rule engines, EDR/MDR AI-based engines, vulnerability scanners. External data sources can comprise at least one of the following: a domain search database, a virus database, a virus information source, a vulnerability database. Internal data sources can comprise at least one of the following: a threat intelligence information source, an incident information source, an asset information source, a vulnerability database. The threat detection components may comprise (in addition to or instead of the earlier components) at least one of the following components: a data source, a data collection agent, a data aggregation and normalization component, a data storage, an analysis engine, alerting and notification component, user interface component, reporting and logging component, an incident response tool, an integration tool, a machine learning algorithm, and an AI-algorithm, a rule engine, a scalability and/or redundancy unit, a threat intelligence feed.

The information provided with the solution of the disclosure relating to vulnerabilities of the network can be used for attack path mapping and/or attack path simulation in determining possible attack paths to the network and/or hosts of the network based (at least in part) on the found vulnerabilities. The attack path mapping and/or attack path simulation may involve for example identifying and analyzing various entry points, vulnerabilities (based on the solution of the disclosure), and attack vectors that attackers could exploit to achieve their objectives and/or identification, threat modeling, vulnerability analysis, and path analysis. Attack path simulation can be done e.g. at a backend system and/or at the at least one server. In attack path mapping a list of vulnerabilities and/or misconfigurations of the at least one host in the network and/or a list of vulnerabilities and/or misconfigurations of the network can be identified. This can be done based on the solution of the disclosure e.g. by requesting this information from a service, for example an internal or external vulnerability management service. In one embodiment of the disclosure information relating to vulnerabilities of the host and/or the network can be received from a vulnerability management service and/or analyzed by a vulnerability management service. If an entry attack vector to a host is found with the attack path simulator, at least one attack path related to the host can be determined and/or created for the attack path map based on the vulnerability and/or misconfiguration information. An attack path map can be formed based on the attack path simulation, e.g. by including attack paths that could be used based on the vulnerabilities and/or misconfigurations of the hosts and/or the network.

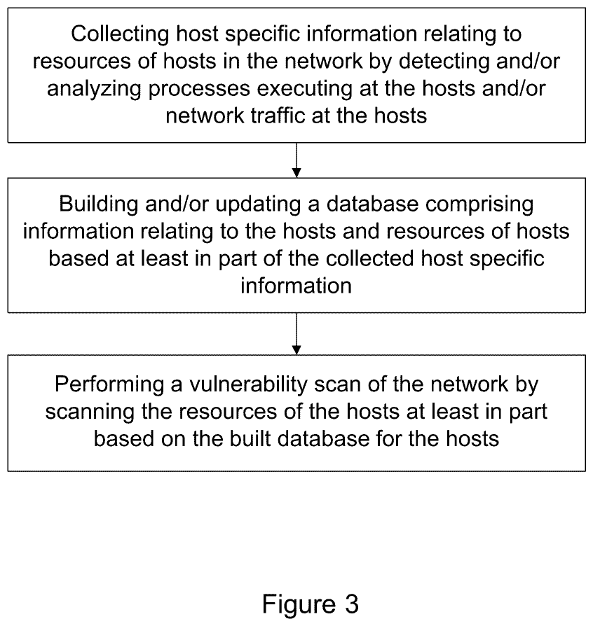

FIG. 3 presents an example method according to one embodiment of the disclosure. The example method comprises collecting host specific information relating to resources of hosts in the network by detecting and/or analyzing processes executing at the hosts and/or network traffic at the hosts, building and/or updating a database comprising information relating to the hosts and resources of hosts based at least in part of the collected host specific information, and performing a vulnerability scan of the network by scanning the resources of the hosts at least in part based on the built database for the hosts.

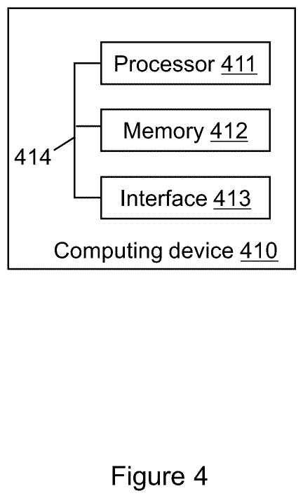

FIG. 4 presents an example computing device, such as a host, an endpoint and/or a server, according to one embodiment of the disclosure. The computing device 410 may, for example, represent a local entity or host 101 in FIG. 1, or may represent a remote entity or server 102 in FIG. 1. The computing device 410 may be configured to perform a procedure and/or exhibit a functionality as described in any one of FIGS. 1 to 3.

The computing device may comprise at least one processor 411 and at least one memory 412 (and possibly also at least one interface 413), which may be operationally connected or coupled, for example by a bus 414 or the like, respectively. The processor 411 of the computing device 410 is configured to read and execute computer program code stored in the memory 412. The processor may be represented by a CPU (Central Processing Unit), a MPU (Micro Processor Unit), etc., or a combination thereof. The memory 412 of the computing device 410 is configured to store computer program code, such as respective programs, computer/processor-executable instructions, macros or applets, etc. or parts of them. Such computer program code, when executed by the processor 411, enables the computing device 410 to operate in accordance with example embodiments of the present disclosure. The memory 412 may be represented by a RAM (Random Access Memory), a ROM (Read Only Memory), a hard disk, a secondary storage device, etc., or a combination of two or more of these. The interface 413 of the computing device 410 is configured to interface with another computing device and/or the user of the computing device 410. That is, the interface 413 may represent a communication interface (including e.g. a modem, an antenna, a transmitter, a receiver, a transceiver, or the like) and/or a user interface (such as a display, touch screen, keyboard, mouse, signal light, loudspeaker, or the like).

In one embodiment of the disclosure actions relating to prioritizing potential treatments for an identified threat and/or security posture improvements can be carried out. In one embodiment of the disclosure an output of the threat detection component relates to at least one of the following: identified vulnerability, identified critical asset, priority of identified vulnerability, priority of critical asses, risk values for business of the identified asset and/or vulnerability, attack path mapping, visualization and reporting artifact.

The data collected with the solution of the disclosure may be stored in a database or similar model for information storage for further use.

In an embodiment, further actions may be taken to secure the computer or the computer network when a threat, vulnerability, misconfiguration, malicious file, application and/or activity has been detected. Also, actions by changing the settings of the computers or other network nodes can be done. Changing the settings may include, for example, one or more nodes (which may be computers or other devices) being prevented from being switched off in order to preserve information in RAM, a firewall may be switched on at one or more nodes to cut off the attacker immediately, network connectivity of one or more of the network nodes may be slowed down or blocked, suspicious files may be removed or placed into quarantine, logs may be collected from network nodes, sets of command may be executed on network nodes, users of the one or more nodes may be warned that a threat or anomaly has been detected and that their workstation is under investigation, and/or a system update or software patch may be sent from the security backend to the nodes. In one embodiment of the disclosure one or more of these actions may be initiated automatically.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein. Lists and groups of examples provided in the description given above are not exhaustive unless otherwise explicitly stated.

1. A method for vulnerability scanning in a network, the network comprising at least one of a host, an endpoint, and a server, wherein the method comprises:
collecting host specific information relating to resources of hosts in the network by detecting or analyzing processes executing at the hosts or network traffic at the hosts, the resources of the hosts relating to at least one of the following: processes being executed at the hosts, ports used by the hosts, and protocols used by the hosts,
building or updating a database comprising information relating to the hosts and to the resources of the hosts based at least in part of the collected host specific information, and
performing a vulnerability scan of the network by scanning the resources of the hosts at least in part based on the built database for the hosts.

2. The method according to claim 1, wherein only the ports or protocols of the hosts are scanned in the vulnerability scan which the hosts are using based on the host specific information in the database.

3. The method according to claim 1, wherein the host specific information relating to the resources of the host is collected by at least one security agent installed to at least one host or network, the security agent being an xDR agent, EDR-agent, MDR-agent, EPP-agent, a vulnerability management system, software catalog, a device firewall, a device application control software, or a network firewall.

4. The method according to claim 1, wherein the host is monitoring for configuration changes on the host or software being added to the host by an agent installed to the host, or wherein information related to the changes or software being added to the host is submitted to be included to the host specific information in the database.

5. The method according to claim 4, wherein the scope of the vulnerability scan at the host is at least in part based on the monitored configuration changes or software being added, so that the vulnerability scan scans only the ports and protocols used by the host.

6. The method according to claim 1, wherein the collected information, comprising host specific information, relates to at least one of the following: what applications are listening to which network ports at a host, what processes or applications the host is executing, what are the names of the processes or applications, what are the version strings of the processes or applications, what are the vendors of the processes and/or applications, what is an IP address of the host, what is operating system of the host.

7. The method according to claim 1, wherein the method further comprises carrying out a full or complete scan comprising a port scan or a vulnerability scan, of the host or the network, wherein the results are compared with the collected information of the database, and wherein an alert is created or sent if there are resources used by the hosts, such as ports, which are not present in the host specific collected information of the database.

8. The method according to claim 7, wherein the method further comprises requesting the host to confirm that the resources, such as used ports, are not used by the host before creating or sending the alert.

9. The method according to claim 1, wherein the method comprises carrying out a port scan on the at least one host and, if previously unused ports are found to be used with the port scan, carrying out a vulnerability scan.

10. The method according to claim 1, wherein the method further comprises scanning at least one cloud service entity and information related to the at least one cloud service entity is submitted to be included to the database.

11. The method according to claim 10, wherein the method further comprises scanning only those cloud service entities that are determined to be present based on the database.

12. The method according to claim 2, wherein the host specific information relating to the resources of the host is collected by at least one security agent installed to at least one host or network, the security agent being an xDR agent, EDR-agent, MDR-agent, EPP-agent, a vulnerability management system, software catalog, a device firewall, a device application control software, or a network firewall.

13. An arrangement for vulnerability scanning comprising at least one host for coordinating or carrying out a vulnerability scan in a network, the network comprising at least one of the host, an endpoint, and a server, the at least one host being directed to, through execution of program instructions by a hardware processor:
collect host specific information relating to resources of the hosts by detecting or analyzing processes executing at the hosts or network traffic at the hosts, the resources of the hosts relating to at least one of the following: processes being executed at the hosts, ports used by the hosts, and protocols used by the hosts,
build or to update a database comprising information relating to the hosts and the resources of hosts based at least in part of the collected host specific information, and
perform a vulnerability scan of the network by scanning the resources of the hosts at least in part based on the built database for the hosts.

14. The arrangement according to claim 13, wherein only the ports or protocols of the hosts are scanned in the vulnerability scan which the hosts are using based on the host specific information in the database.

15. The arrangement according to claim 13, wherein the host specific information relating to the resources of the host is collected by at least one security agent installed to at least one host or network, the security agent being an xDR agent, EDR-agent, MDR-agent, EPP-agent, a vulnerability management system, software catalog, a device firewall, a device application control software, or a network firewall.

16. The arrangement according to claim 13, wherein the host is monitoring for configuration changes on the host or software being added to the host by an agent installed to the host, or wherein information related to the changes or software being added to the host is submitted to be included to the host specific information in the database.

17. The arrangement according to claim 16, wherein the scope of the vulnerability scan at the host is at least in part based on the monitored configuration changes or software being added, so that the vulnerability scan scans only the ports and protocols used by the host.

18. The arrangement according to claim 13, wherein the collected information, comprising host specific information, relates to at least one of the following: what applications are listening to which network ports at a host, what processes or applications the host is executing, what are the names of the processes or applications, what are the version strings of the processes or applications, what are the vendors of the processes and/or applications, what is an IP address of the host, what is operating system of the host.

19. The arrangement according to claim 13, wherein the at least one host is further directed to carry out a full or complete scan comprising a port scan or a vulnerability scan, of the host or the network, wherein the results are compared with the collected information of the database, and wherein an alert is created or sent if there are resources used by the hosts, such as ports, which are not present in the host specific collected information of the database.

20. A non-transitory computer-readable medium comprising a computer program configured to perform the method according to claim 1.
